(19) United States
(12) Patent Application Publication
(10) Pub. No.: US 2026/0022441 A1
(43) Pub. Date: Jan. 22, 2026

(54) HIGH-TEMPERATURE ABLATION RESISTANT HIGH-ENTROPY ALLOY FOR THROAT LINER AND MANUFACTURING METHOD THEREFOR

(71) Applicant: XI'AN TECHNOLOGICAL UNIVERSITY, Xi'an (CN)

(72) Inventors: Jian CHEN, Xi'an (CN); Shuaidan LU, Xi'an (CN); Yunzi LIU, Xi'an (CN); Wenting SHAO, Xi'an (CN); Jiahua HE, Xi'an (CN); Jialiang ZHOU, Xi'an (CN)

(21) Appl. No.: 19/089,160

(22) Filed: Mar. 25, 2025

(30) Foreign Application Priority Data
Jul. 16, 2024 (CN) 2024109542220

(51) Int. Cl. C22C 27/04; F02K 9/97

(52) U.S. Cl. CPC C22C 27/04; F02K 9/974; F05D 2230/22; F05D 2300/17

(57) ABSTRACT

Disclosed in the present disclosure are a high-temperature ablation resistant high-entropy alloy for a throat liner and a manufacturing method therefor. The high-entropy alloy for a throat liner has an expression: WₐMo_{b}Ta_{c}X_{d}, wherein 15%≤a≤50%, 15%≤b≤50%, 15%≤c≤50%, 0%<d≤50%, and a+b+c+d=100%. The high-entropy alloy for a throat liner has excellent high-temperature strength and stability, and the linear ablation rate after long-term ablation at high temperature is extremely small, and is close to that of zero ablation, which is beneficial to improving control precision and efficiency of rocket motors.

### CROSS-REFERENCE TO RELATED APPLICATION

This application claims priority from the Chinese patent application 2024109542220 filed Jul. 16, 2024, the content of which is incorporated herein in the entirety by reference.

### TECHNICAL FIELD

The present disclosure relates to the technical field of ablation resistant material preparation, and in particular to a high-temperature ablation resistant high-entropy alloy for a throat liner and a manufacturing method therefor.

### BACKGROUND

With the increasing requirements for the speed and the range, solid rocket motor throat liners face higher temperature ablation and longer periods of ablation, such as at a temperature of about 3000K, the throat liners can withstand long-term ablation for several hundred seconds. A C/C composite material in the existing throat liner material has good high temperature strength, high temperature fracture toughness, excellent thermal shock resistance and reliability, but is expensive and has poor ablation resistance in an aerobic environment at high temperature. Copper infiltrated tungsten has excellent ablation resistance, but its specific weight is high, and cannot meet light weight requirements. Ultra-high-temperature ceramic bulk materials have the advantages of ultra-high temperature resistance, high thermal conductivity, and high strength, and are also used to manufacture a throat liner, but have high brittleness themselves, small damage tolerance, poor thermal shock resistance, it is difficult to solve the problem of non-uniformity during manufacture, structural damage is easy to occur during ablation, so the reliability is low. Graphite is also used as a nozzle material, but has poor high-temperature oxidation ablation resistance and poor ion erosion resistance, the nozzle size changes greatly under the erosion of a high-speed and high-pressure flame flow, which has a great impact on the performance of a rocket motor, and at the same time, its brittleness is high, and it is prone to catastrophic brittle fracture, resulting in poor reliability. Other heat-resistant alloys are severely ablated at higher temperatures, and can no longer meet the performance requirements, and there is an urgent need for new high-temperature ablation resistant materials and preparation techniques thereof.

Therefore, the present disclosure provides a high-temperature ablation resistant high-entropy alloy for a throat liner and a manufacturing method therefor.

### SUMMARY

In order to solve the above problems, the present disclosure proposes a high-temperature ablation resistant high-entropy alloy for a throat liner and a manufacturing method therefor. The high-entropy alloy for a throat liner has an expression: WₐMo_{b}Ta_{c}X_{d}, wherein 15%≤a≤50%, 15%≤b≤50%, 15%≤c≤50%, 0%<d≤50%, and a+b+c+d=100%. The melting points of oxides of W, Mo, Ta and X elements are relatively high, so that the volatilization enthalpies of the oxides are also relatively high, and the volatilization of the oxides takes away a large amount of heat during the ablation process, reducing the stagnation temperature of the surface of the high-entropy alloy for a throat liner, improving the ablation resistance, and resisting the erosion effect of a flame flow at a high temperature. The high-entropy alloy for a throat liner has excellent high-temperature strength and stability, and the linear ablation rate after long-term ablation at high temperature is extremely small, and is close to that of zero ablation, which is beneficial to improving control precision and efficiency of rocket motors.

In particular, an object of the present disclosure is to provide the following aspects:
in a first aspect, there is provided a high-entropy alloy for a throat liner, having a chemical composition represented by: WₐMo_{b}Ta_{c}X_{d}, wherein 15%≤a≤50%, 15%≤b≤50%, 15%≤c≤50%, 0%<d≤50%, and a+b+c+d=100%.
X is any one or more of Nb, Ti, V, Zr, and Hf.

The high-entropy alloy for a throat liner has a density of 10-16 g/cm³, a densification of 85%-95%, and a compressive strength of 405-510 MPa at 1600° C.

The high-entropy alloy for a throat liner has an average linear ablation rate of −0.5 μm/s to 5 μm/s after ablated in an oxyacetylene flame with a heat flux density of 4 MW/m² for 240 s.

In a second aspect, provided is a method for manufacturing the high-entropy alloy for a throat liner in the first aspect, including:
Step 1, mixing and ball-milling a W metal, a Mo metal, a Ta metal and an X metal to obtain a mixed powder;
Step 2, sintering the mixed powder to obtain a high-entropy alloy block; and
Step 3, machining the high-entropy alloy block into the high-entropy alloy for a throat liner.

In a third aspect, provided is a rocket motor, including the high-entropy alloy for a throat liner in the first aspect.

The beneficial effects of the present disclosure include:
(1) The high-entropy alloy for a throat liner provided by the present disclosure has high densification, excellent strength, ablation resistance and thermal shock resistance, can resist long-term ablation by a high temperature flame flow of 3000 K, and at the same time, the density is greatly lower than that of copper infiltrated tungsten.
(2) Oxides of refractory metal elements selected by the high-entropy alloy for a throat liner according to the present disclosure have a relatively high melting point, thus the volatilization enthalpies of the oxides are also relatively high, and the volatilization of the oxides takes away a large amount of heat during the ablation process, reducing the stagnation temperature of the surface of the high-entropy alloy for a throat liner, improving the ablation resistance, and resisting the erosion effect of a flame flow at a high temperature.
(3) The high-entropy alloy for a throat liner provided by the present disclosure has excellent high-temperature strength and stability, and the linear ablation rate after long-term ablation at high temperature is extremely small, and is close to that of zero ablation, which is beneficial to improving control precision and efficiency of rocket motors.
(4) The method for manufacturing the high-entropy alloy for a throat liner provided by the present disclosure is simple and controllable and low in cost.

### BRIEF DESCRIPTION OF DRAWINGS

Various other advantages and benefits of the present disclosure will become apparent to those of ordinary skill in the art upon reading the following detailed description of the preferred embodiments. The drawings are only for the purpose of illustrating preferred embodiments and are not to be construed as limiting of the present disclosure. Obviously, the drawings described below are merely some embodiments of the present disclosure, and for those of ordinary skill in the art, other drawings can also be obtained according to these drawings without paying inventive steps.

In the drawings:

FIG. 1 shows a macroscopic optical picture of a high-entropy alloy block manufactured in Comparative example 1 after ablation;

FIG. 2 shows a field view of an oxyacetylene flame ablation test of a high-entropy alloy block manufactured in Example 1;

FIG. 3 shows a scanning electron microscope (SEM) characterization diagram of the high-entropy alloy block manufactured in Example 1;

FIG. 4 shows an X-ray diffraction (XRD) pattern of the high-entropy alloy block manufactured in Example 1;

FIG. 5 shows a macroscopic optical photograph of the high-entropy alloy block manufactured in Example 1 before ablation;

FIG. 6 shows a macroscopic optical photograph of the high-entropy alloy block manufactured in Example 1 after ablation;

FIG. 7 shows a scanning electron microscope (SEM) characterization diagram of the high-entropy alloy block manufactured in Example 1 after ablation;

FIG. 8 shows a picture of a high-entropy alloy for a throat liner manufactured in Example 1;

FIG. 9 shows a macroscopic optical photograph of a high-entropy alloy block manufactured in Example 2 after ablation;

FIG. 10 shows a macroscopic optical photograph of a high-entropy alloy block manufactured in Example 3 after ablation;

FIG. 11 shows a macroscopic optical photograph of a high-entropy alloy block manufactured in Example 4 after ablation.

### DETAILED DESCRIPTION OF THE INVENTION

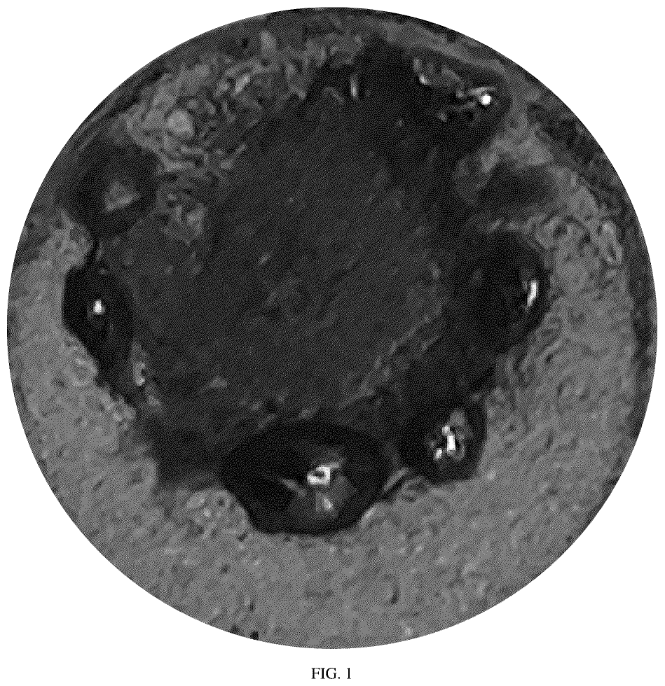

Specific examples of the present disclosure will be described in more detail below with reference to FIGS. 1 to 11. Although specific examples of the present disclosure are illustrated in the accompanying drawings, it should be understood that the present disclosure may be implemented in various forms and should not be limited by the examples set forth herein. Rather, these examples are provided to enable a more thorough understanding of the present disclosure, and fully convey the scope of the present disclosure to those skilled in the art.

It should be noted that certain terms are used in the specification and claims to refer to specific components. It will be appreciated by those skilled in the art that different terms may be used to refer to the same component. The specification and claims do not use differences in terms as a way of distinguishing the components, but rather use differences in function of components as a criterion for differentiation. The term “comprise” or “include” mentioned throughout the specification and claims is an open-ended term, thus it should be construed as “including but not limited to.” The following description in the specification relates to preferred embodiments for implementing the present disclosure, but the description is for the purpose of general principles of the description and is not intended to limit the scope of the present disclosure. The scope of protection of the present disclosure shall be determined as defined by the appended claims.

In the description of the present disclosure, it should be noted that the orientation or positional relationship indicated by the terms “upper”, “lower”, “inner”, “outer”, “front”, “rear” and the like is based on the orientation or positional relationship in the operational state of the present disclosure, only for case of description of the present disclosure and for simplicity of description, not indicating or implying that the device or element referred to must have a particular orientation, and be constructed and operated in a particular orientation, and therefore should not be construed as limiting the present disclosure. Moreover, the terms “first”, “second”, “third”, and “fourth” are used for descriptive purposes only and are not to be construed as indicating or implying relative importance.

In order to facilitate understanding of the examples of the present disclosure, further explanation will be given below by taking specific examples as an example with reference to the accompanying drawings, and the accompanying drawings are not to be construed as limiting the examples of the present disclosure.

In a first aspect, according to the present disclosure, provided is a high-temperature ablation resistant high-entropy alloy for a throat liner, having a material expression: WₐMo_{b}Ta_{c}X_{d}, a, b, c, and d being the atomic percent contents of W, Mo, Ta and X, respectively, wherein 15%≤a≤50%, 15%≤b≤50%, 15%≤c≤50%, 0%<d≤50%, and a+b+c+d=100%.

Further, X is any one or more of Nb, Ti, V, Zr, and Hf.

According to preferred embodiments, metal elements in the high-entropy alloy for a throat liner have an equal atomic percent content. For example, the expression for the high-entropy alloy for a throat liner is: W_{0.25}Mo_{0.25}Ta_{0.25}Nb_{0.25}, W_{0.2}Mo_{0.2}Ta_{0.2}Nb_{0.2}Ti_{0.2}, W_{0.2}Mo_{0.2}Ta_{0.2}Nb_{0.2}V_{0.2}, or W_{0.167}Mo_{0.167}Ta_{0.167}Nb_{0.167}Ti_{0.166}V_{0.166}.

In the present disclosure, crystal structures of the elements are similar, and a single solid solution structure can be formed, and at the same time, the difference in atomic size, the difference in electronegativity, the concentration of valence electrons and the like, and the effects of the lattice distortion and the like caused by the mixing of the elements make the formed high-entropy alloy for a throat liner have the properties such as high-temperature structural thermal stability, high temperature strength and the like, which are far superior to those of the conventional alloy throat liner. The above metal elements and related oxides thereof have the characteristics of low saturation vapor pressure, high melting point and volatilization enthalpy, the melting point of W, Mo, and V is high, and therefore the volatilization enthalpies of the oxides thereof are also relatively high, and during the ablation process, the oxides thereof take away a large amount of heat during the volatilization process, reducing the stagnation temperature of the surface of the high-entropy alloy for a throat liner, improving the ablation resistance, and resisting the erosion effect of a flame flow at a high temperature. The oxide and complex oxides thereof generated in the ablation process of the high-entropy alloy for a throat liner have good fluidity and densification, which play a role in self-healing of ablation cracks and oxidation resistance, further improving the ablation resistance of the high-entropy alloy for a throat liner.

In the present disclosure, the structure of the high-entropy alloy for a throat liner exhibits a BCC phase structure.

In the present disclosure, the high-entropy alloy for a throat liner has a density of 10-16 g/cm³; a densification of 90%-95%; a melting point of 2200-2900° C., a high melting point naturally leading to a high melting enthalpy; a compressive strength of 405-510 MPa at 1600° C.; and an average linear ablation rate of −0.5 μm/s to 5 μm/s after ablated in an oxyacetylene flame with a heat flux density of 4 MW/m² for 240 s.

In preferred embodiments, the compressive strength of W_{0.25}Mo_{0.25}Ta_{0.25}Nb_{0.25} at 1600° C. reaches 405 MPa, the compressive strength of W_{0.2}Mo_{0.2}Ta_{0.2}Nb_{0.2}V_{0.2} at 1600° C. reaches 477 MPa, the compressive strength of W_{0.2}Mo_{0.2}Ta_{0.2}Nb_{0.2}Ti_{0.2} at 1600° C. reaches 445 MPa, and the compressive strength of W_{0.167}Mo_{0.167}Ta_{0.167}Nb_{0.167}Ti_{0.166}V_{0.166} at 1600° C. reaches 510 MPa. The high-entropy alloy for a throat liner will resist erosion by a high-temperature flame flow due to its excellent compressive strength.

In a second aspect, provided is a method for manufacturing the high-entropy alloy for a throat liner in the first aspect, including:
Step 1, mixing and ball-milling a W metal, a Mo metal, a Ta metal and an X metal to obtain a mixed powder;
Step 2, sintering the mixed powder to obtain a high-entropy alloy block; and
Step 3, machining the high-entropy alloy block into the high-entropy alloy for a throat liner.

In particular:

Step 1, the W metal, the Mo metal, the Ta metal and the X metal are mixed and ball-milled to obtain the mixed powder.

In the step 1, by utilizing high entropy effects, slow diffusion effects, lattice distortion effects and cocktail effects of high-entropy alloys, high-entropy alloy components are selected based on high thermodynamic mixing enthalpy, low component saturation vapor pressure, high volatilization enthalpy of reaction products, high melting point of reaction products, and kinetic high temperature ablation self-healing characteristics, a low oxygen diffusion coefficient at high temperature, high strength at high temperature, a dense oxidation product layer, etc.; based on the high entropy material formation criteria, it is finally determined that an expression used is WₐMo_{b}Ta_{c}X_{d}, i.e., the W metal, the Mo metal, the Ta metal, and the X metal are used in amounts that satisfy: WₐMo_{b}Ta_{c}X_{d}, a, b, c, and d being the atomic percent contents of W, Mo, Ta, and X, respectively, 15%≤a≤50%, 15%≤b≤50%, 15%≤c≤50%, 0%<d≤50%, and a+b+c+d=100%.

Further, X is any one or more of Nb, Ti, V, Zr, and Hf.

According to preferred embodiments, metal elements in the high-entropy alloy for a throat liner have an equal atomic percent content, i.e., each metal is added in an equimolar ratio. For example, each metal element is added in an amount that satisfies: W_{0.25}Mo_{0.25}Ta_{0.25}Nb_{0.25}, W_{0.2}Mo_{0.2}Ta_{0.2}Nb_{0.2}Ti_{0.2}, W_{0.2}Mo_{0.2}Ta_{0.2}Nb_{0.2}V_{0.2}, or W_{0.167}Mo_{0.167}Ta_{0.167}Nb_{0.167}Ti_{0.166}V_{0.166}.

In the step 1, in order to ensure the uniformity of the mixed powder of elementary substances, thereby ensuring the uniformity of the composition of the manufactured high-entropy alloy block, it is preferred that each metal powder has a particle size of 20-50 μm, an impurity content is 0.1% or less, and an oxygen content is 100 ppm or less, so as to ensure the uniformity of the composition of the manufactured high-entropy alloy block.

In the step 1, the ball milling efficiency is closely related to the ball milling parameters.

The amount of ball loading is determined according to the required ball milling efficiency to achieve the optimal impact and grinding condition. The ball-to-powder weight ratio is 3-7:1, preferably 4-6:1, for example, 5:1.

In the step 1, a ball milling speed is 100-300 r/min, preferably 200-300 r/min, e.g., 250 r/min.

According to the present disclosure, as the ball milling speed is accelerated, the powder particles of W, Mo, Ta and X are refined and distributed more uniformly, and the uniformity and densification of the microstructure of the manufactured high-entropy alloy for a throat liner is improved; however, an excessively high ball milling speed causes W, Mo, Ta and X to be neither stirred nor crushed, and there is a possibility of segregation, which in turn results in reduced uniformity and densification of the manufactured high-entropy alloy for a throat liner.

In the step 1, the ball milling time is 4-12 h, preferably 4-6 h, more preferably 6 h.

In the present disclosure, the ball milling time is important in order to improve the degree of dispersion of W, Mo, Ta and X and the mechanical properties of the manufactured high-entropy alloy for a throat liner. As the ball milling time is extended, the raw materials are dispersed more and more uniformly, but the ball milling time is too long, the refining effect is not obvious, and instead, the activity of the raw materials is continuously increased during the ball milling process, resulting in severe work hardening.

Step 2, the mixed powder is sintered to obtain the high-entropy alloy block.

In the step 2, the sintering is spark plasma sintering or high temperature hot press sintering.

Further, the high-entropy alloy block is manufactured by adopting the spark plasma sintering, which greatly shortens the reaction time, and is more dense because of the spark plasma sintering; and it is more advantageous to achieve precise control of the thickness of the high-entropy alloy block.

In the step 2, the sintering temperature is 1600° C.-2200° C., preferably 1800° C.-2000° C., for example, 1900° C.

The temperature is a key parameter determining the formation of the high-entropy alloy block, and at a high temperature, a diffusion rate between elements increases, helping to form a uniform BCC structure of the high-entropy alloy block; too high a temperature may result in the possible formation of brittle phases, affecting the plasticity and toughness of the high-entropy alloy block.

In the step 2, the sintering time is 2-20 min, preferably 10-20 min, for example, 10 min.

The holding time has an important effect on the grain size and uniformity of the high-entropy alloy block, and the longer holding time will lead to grain growth.

Further, the sintering is performed at a heating rate of 30-100° C./min, preferably 40-50° C./min, for example, 50° C./min.

A higher heating rate will result in uneven grain growth, affecting the uniformity of the high-entropy alloy block.

Further, the sintering is performed under a pressure of being maintained at 10-30 Mpa, preferably 20-30 Mpa, for example, 30 Mpa.

A proper pressure helps to increase the densification and uniformity of the high-entropy alloy block.

In the step 2, during sintering, the temperature is increased from normal temperature, e.g., 25° C., to the desired temperature for sintering.

In the step 2, vacuuming to 7 Pa or less before sintering is beneficial for controlling the content of impurities such as oxygen and nitrogen in the manufactured high-entropy alloy at a relatively low level.

Further, during sintering, an inert gas such as argon and helium is used as a protective gas, e.g., argon is used as a protective gas. The protective gas needs to be introduced from before the sintering to a stage of cooling to room temperature after the end of the sintering in order to protect the high-entropy alloy from reacting with oxygen and nitrogen in the air to form an impurity phase at a high temperature stage.

In the step 2, after sintering, the temperature is reduced to 500-700° C. at a cooling rate of 20-100° C./min, followed by natural cooling to room temperature, which prevents direct cooling after the end of the sintering from causing the high-entropy alloy block to crack during quenching, and a cooling procedure for the sintering is not strictly limited.

Further preferably, after sintering, the temperature is reduced to 500-700° C. at a cooling rate of 30-50° C./min, followed by natural cooling to room temperature.

Still more preferably, after sintering, the temperature is reduced to 500° C. at a cooling rate of 50° C./min, followed by natural cooling to room temperature.

Step 3, the high-entropy alloy block is machined into the high-entropy alloy for a throat liner.

In the step 3, the high-entropy alloy block is cut, for example, by using a lathe to obtain the high-entropy alloy for a throat liner.

In a third aspect, provided is use of the high-entropy alloy for a throat liner according to the first aspect, or the high-entropy alloy for a throat liner manufactured by the method according to the second aspect in a rocket motor.

In the present disclosure, the high-entropy alloy for a throat liner has the characteristics of high melting point, high-temperature structural stability, high melting enthalpy, excellent high-temperature strength, high oxide volatilization enthalpy, etc., and can resist long-term ablation by a high-temperature flame flow; and has excellent thermal shock resistance, and can adapt to the thermal stress caused by a temperature difference due to transient strong thermal shock and a variable thrust during service; in addition, the high-entropy alloy for a throat liner has high damage tolerance, avoiding catastrophic damage; finally, after the high-entropy alloy for a throat liner is ablated in an oxyacetylene flame with a heat flux density of 4 MW/m² for 240 s, the average linear ablation rate is close to that of zero ablation, and the ablation resistance is far superior to that of a carbon-carbon composite, graphite and copper infiltrated tungsten, etc., and the high-entropy alloy for a throat liner can be serviced in a complex ablation environment with oxygen and no oxygen, etc., and the oxides generated by oxidation during ablation have excellent high-temperature strength and stability, and the excellent ablation resistance is beneficial to improve control precision and efficiency of rocket motors.

The present disclosure is further described below by means of specific examples, but these examples are merely illustrative and do not limit the scope of protection of the present disclosure in any way.

### Example 1

A W metal powder, a Mo metal powder, a Ta metal powder and a Nb metal powder were mixed and ball-milled in an equal molar ratio to obtain a mixed powder, wherein a ball-to-powder weight ratio was 5:1, a ball milling speed was 250 r/min, and the ball milling time was 6 h; and the mixed powder was sintered by spark plasma sintering to obtain a high-entropy alloy block, wherein vacuuming was performed to 6 Pa or less before sintering, the temperature was increased from 25° C. to 1800° C. at a heating rate of 100° C./min, heat preservation was performed at 1800° C. for 10 min, the pressure was maintained at 30 MPa during sistering, and after sintering, the temperature was decreased to 500° C. at a cooling rate of 50° C./min, followed by natural cooling to room temperature, the high-entropy alloy block having a density of 13.6 g/cm³, a densification of 91%, a melting point of 2873.5° C., and a compressive strength of 405 MPa at 1600° C.

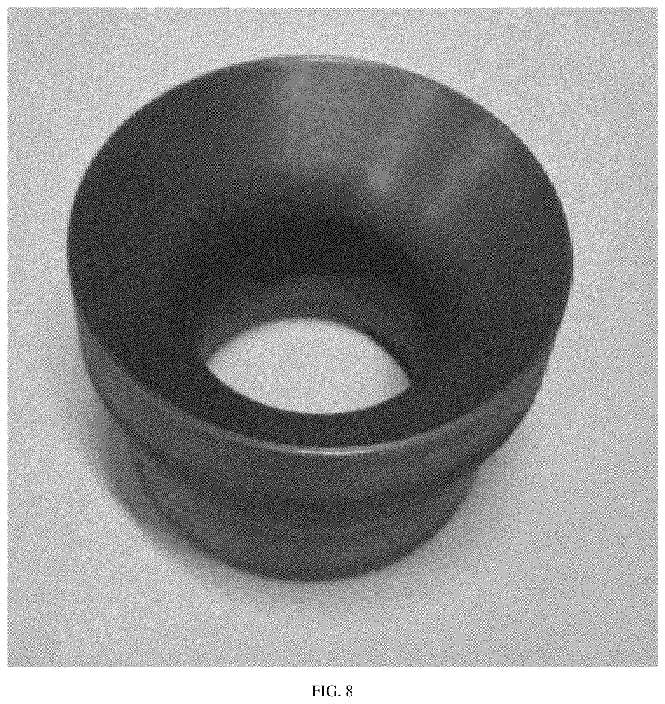

The high-entropy alloy block was then cut by using a lathe to manufacture a high-entropy alloy for a throat liner, having an expression of W_{0.25}Mo_{0.25}Ta_{0.25}Nb_{0.25}. FIG. 8 shows a picture of the high-entropy alloy for a throat liner, and it can be seen that its morphology is regular.

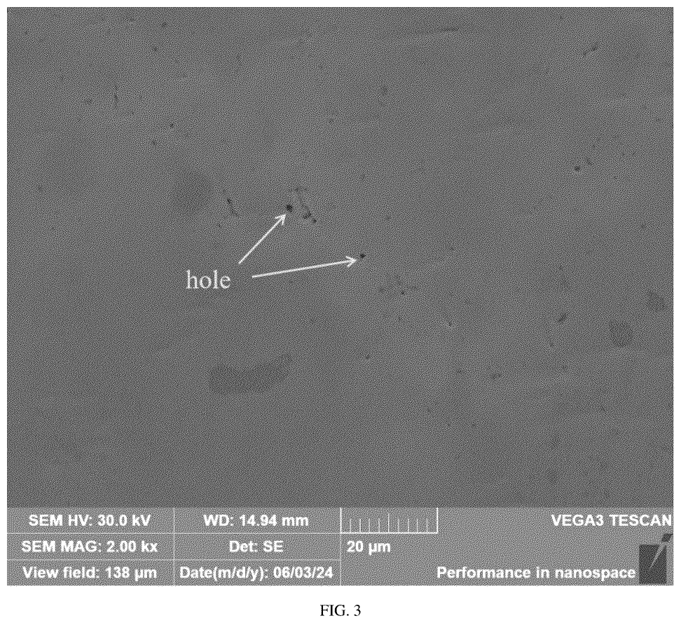

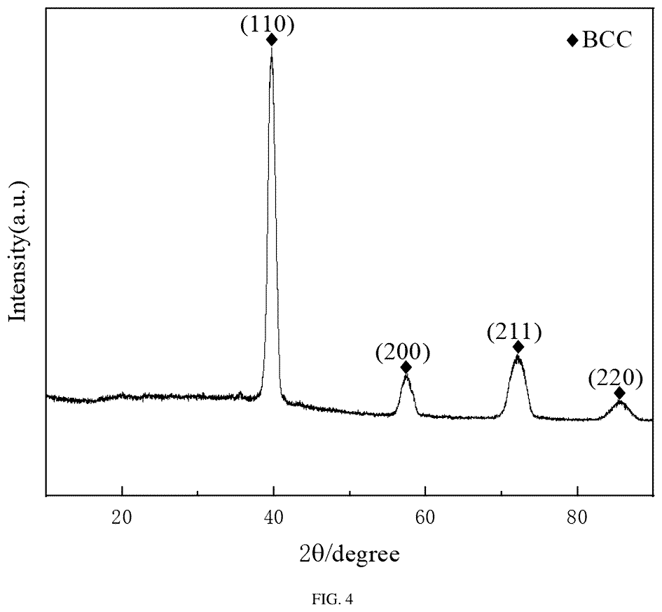

FIG. 3 shows a scanning electron microscope (SEM) characterization diagram of the manufactured high-entropy alloy block, and it can be seen that the manufactured high-entropy alloy block is uniform and dense as a whole, and no obvious holes or cracks are observed. FIG. 4 shows an X-ray diffraction (XRD) pattern of the manufactured high-entropy alloy block. The results show that the manufactured high-entropy alloy block has a compositional morphology of a single BCC phase, and its main diffraction peak has a high intensity and a narrow width, indicating that its crystallinity is very high.

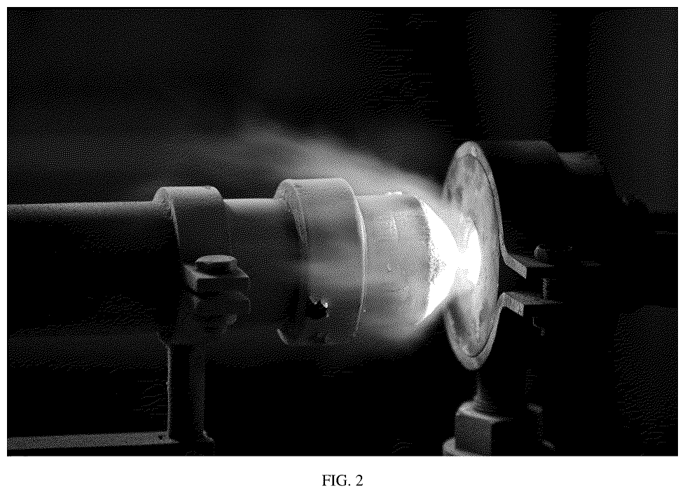

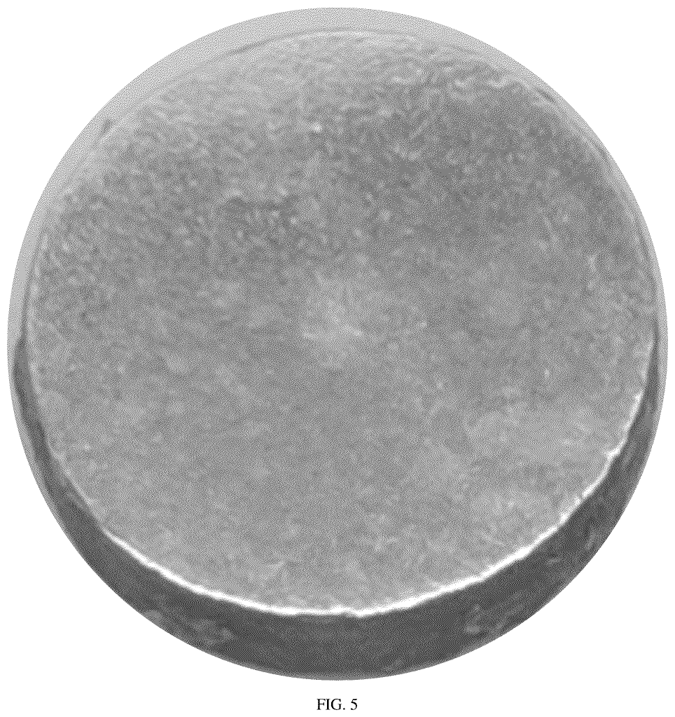

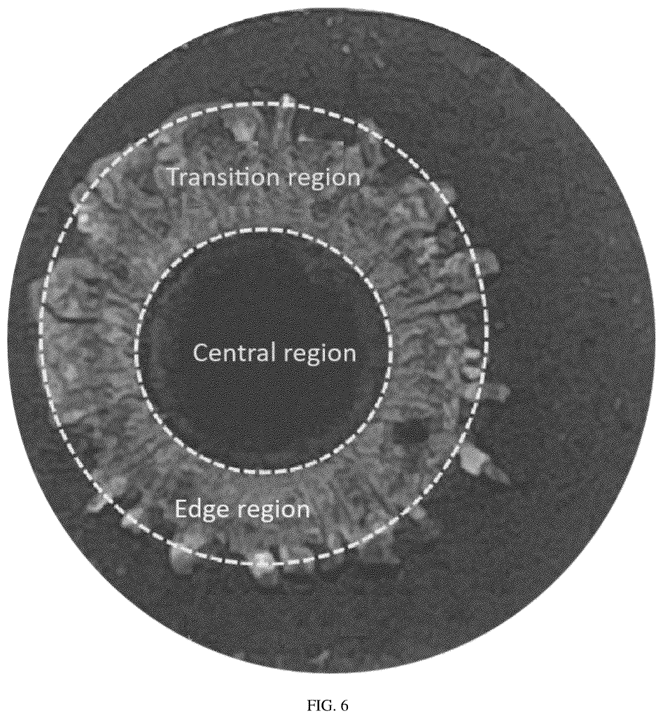

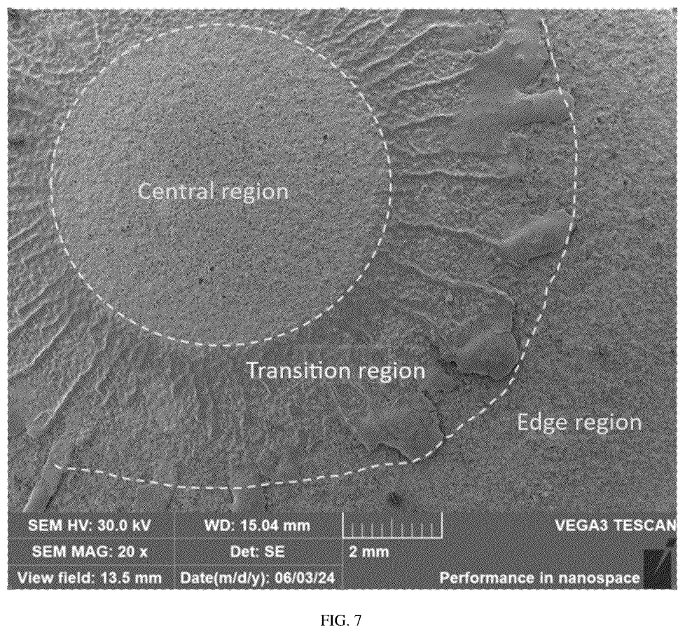

FIG. 5 shows a macroscopic optical photograph of the manufactured high-entropy alloy block before ablation, and the surface is flat and free of defects before ablation. FIG. 2 shows a field view of an oxyacetylene flame ablation test of the high-entropy alloy block. The ablation conditions referred to the oxyacetylene ablation conditions in GJB 323B-2018, “Ablative material ablation test method” (a heat flux density of 4186.8±418.68 kW/m²), after ablated for 240 seconds, the manufactured high-entropy alloy block has a line ablation rate of −0.49 μm/s, with substantially no ablation damage, showing excellent ablation resistance. FIG. 6 shows a macroscopic optical photograph of the manufactured high-entropy alloy block after ablation. As can be seen from the photograph after ablation, its surface was divided into a central region, a transition region, and an edge region, and there were no obvious ablation pits, showing excellent ablation resistance, and the blown-away melt appeared in the transition region. FIG. 7 shows a scanning electron microscope (SEM) characterization diagram of the manufactured high-entropy alloy block after ablation, and it can be clearly seen that the overall morphology is intact and no cracking and spalling occurs. As can be seen from FIGS. 5 to 7, the ablation according to the present disclosure is long-term ablation (the ablation time lasting 150 s or more), the stagnation temperature is high, and the manufactured high-entropy alloy block exhibits excellent ablation resistance. This is due to the high-temperature strength and good thermal stability of the raw materials and their oxides, and the ablation resistance is provided during long-term ablation by virtue of surface oxidative volatilization, surface melting, oxide melting physical and chemical reactions, and high-temperature thermal stability and high-temperature strength of the high-entropy alloy block.

The thermal shock resistance of the manufactured high-entropy alloy block was tested by intermittent ablation in an oxyacetylene flame with a heat flux density of 4 MW/m², wherein the ablation was performed for 10 s, was stopped for 10 s, was performed for 10 s again, and was stopped 10 s, and the process was repeated, and the number of ablations was calculated. The manufactured high-entropy alloy block of W_{0.25}Mo_{0.25}Ta_{0.25}Nb_{0.25} underwent 30 intermittent ablations without cracks, showing excellent thermal shock resistance to sharp temperature increases.

### Example 2

A W metal powder, a Mo metal powder, a Ta metal powder, a Nb metal powder and a Ti metal powder were mixed and ball-milled in an equal molar ratio to obtain a mixed powder, wherein a ball-to-powder weight ratio was 5:1, a ball milling speed was 300 r/min, and the ball milling time was 5 h; and the mixed powder was sintered by spark plasma sintering to obtain a high-entropy alloy block, wherein vacuuming was performed to 7 Pa or less before sintering, the temperature was increased from 25° C. to 1900° C. at a heating rate of 50° C./min, heat preservation was performed at 1900° C. for 5 min, the pressure was maintained at 25 MPa during sistering, and after sintering, the temperature was decreased to 500° C. at a cooling rate of 40° C./min, followed by natural cooling to room temperature, the high-entropy alloy block having a density of 11.7 g/cm³, a densification of 94%, a melting point of 2632.4° C., and a compressive strength of 445 MPa at 1600° C.

The high-entropy alloy block was then cut by using a lathe to manufacture a high-entropy alloy for a throat liner, having an expression of W_{0.2}Mo_{0.2}Ta_{0.2}Nb_{0.2}Ti_{0.2}.

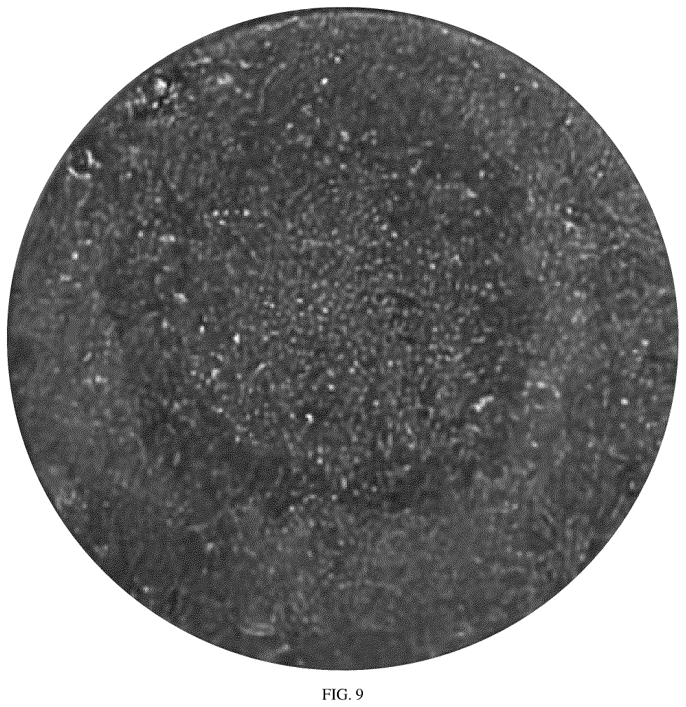

The high-entropy alloy block manufactured in this example was ablated in the same manner as that in Example 1, and FIG. 9 shows a macroscopic optical photograph of the manufactured high-entropy alloy block after ablation. As can be seen from the photograph after ablation, there were no obvious ablation pits on the surface, showing excellent ablation resistance.

### Example 3

A W metal powder, a Mo metal powder, a Ta metal powder, a Nb metal powder and a V metal powder were mixed and ball-milled in an equal molar ratio to obtain a mixed powder, wherein a ball-to-powder weight ratio was 5:1, a ball milling speed was 300 r/min, and the ball milling time was 4 h; and the mixed powder was sintered by spark plasma sintering to obtain a high-entropy alloy block, wherein vacuuming was performed to 6 Pa or less before sintering, the temperature was increased from 25° C. to 1800° C. at a heating rate of 50° C./min, heat preservation was performed at 1800° C. for 5 min, the pressure was maintained at 30 MPa during sistering, and after sintering, the temperature was decreased to 500° C. at a cooling rate of 45° C./min, followed by natural cooling to room temperature, the high-entropy alloy block having a density of 12.3 g/cm³, a densification of 90%, a melting point of 2676.8° C., and a compressive strength of 477MPa at 1600° C.

The high-entropy alloy block was then cut by using a lathe to manufacture a high-entropy alloy for a throat liner, having an expression of W_{0.2}Mo_{0.2}Ta_{0.2}Nb_{0.2}V_{0.2}.

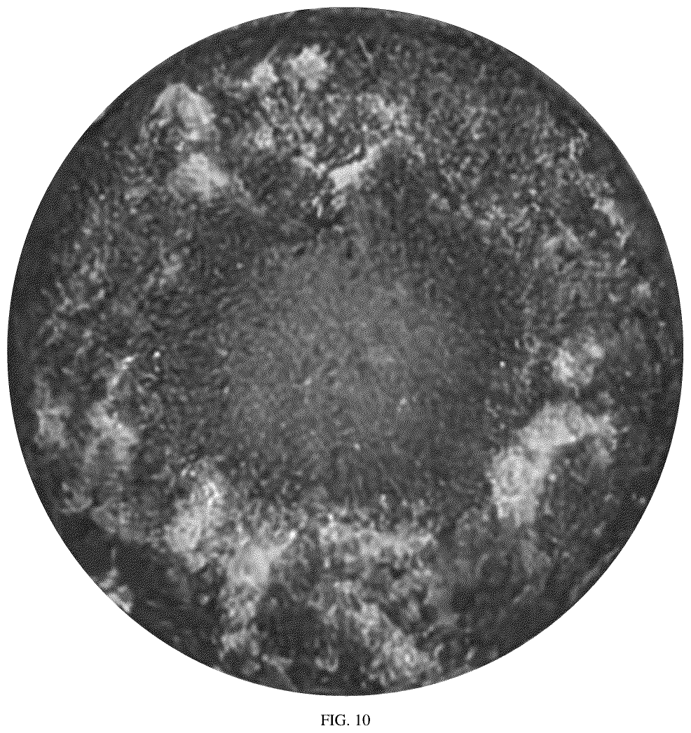

The high-entropy alloy block manufactured in this example was ablated in the same manner as that in Example 1, and FIG. 10 shows a macroscopic optical photograph of the manufactured high-entropy alloy block after ablation. As can be seen from the photograph after ablation, there were no obvious ablation pits on the surface, showing excellent ablation resistance.

### Example 4

A W metal powder, a Mo metal powder, a Ta metal powder, a Nb metal powder, a V metal powder and a Ti metal powder were mixed and ball-milled in an equal molar ratio to obtain a mixed powder, wherein a ball-to-powder weight ratio was 5:1, a ball milling speed was 200 r/min, and the ball milling time was 6 h; and the mixed powder was sintered by spark plasma sintering to obtain a high-entropy alloy block, wherein vacuuming was performed to 6 Pa or less before sintering, the temperature was increased from 25° C. to 2000° C. at a heating rate of 30° C./min, heat preservation was performed at 2000° C. for 15 min, the pressure was maintained at 20 MPa during sistering, and after sintering, the temperature was decreased to 500° C. at a cooling rate of 30° C./min, followed by natural cooling to room temperature, the high-entropy alloy block having a density of 10.9 g/cm³, a densification of 93%, a melting point of 2508.6° C., and a compressive strength of 510 MPa at 1600° C. The high-entropy alloy block was then cut by using a lathe to manufacture a high-entropy alloy for a throat liner, having an expression of W_{0.167}Mo_{0.167}Ta_{0.167}Nb_{0.167}Ti_{0.166}V_{0.166}.

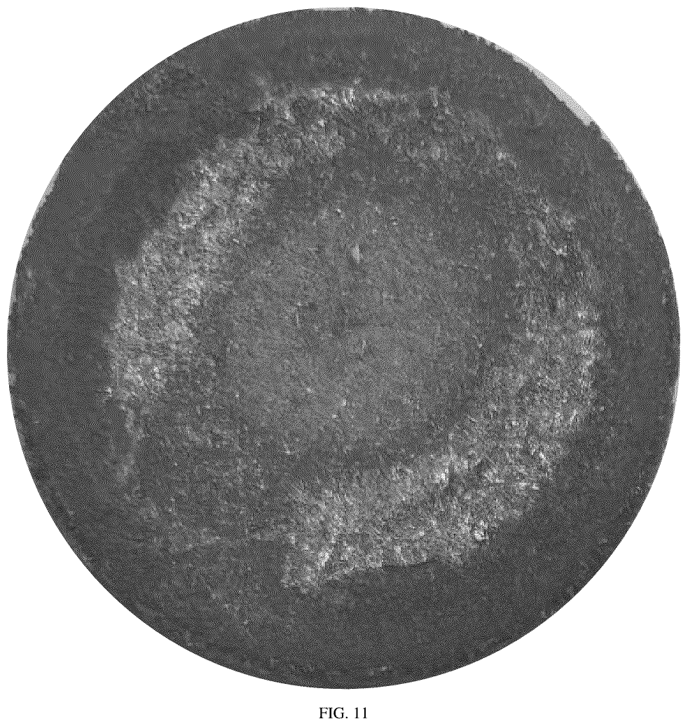

The high-entropy alloy block manufactured in this example was ablated in the same manner as that in Example 1, with a linear ablation rate of −0.6 μm/s. FIG. 11 shows a macroscopic optical photograph of the manufactured high-entropy alloy block after ablation. As can be seen from the photograph after ablation, there were no obvious ablation pits on the surface, showing excellent ablation resistance.

The thermal shock resistance of the manufactured high-entropy alloy block was tested by intermittent ablation in an oxyacetylene flame with a heat flux density of 4 MW/m², wherein the ablation was performed for 10 s, was stopped for 10 s, was performed for 10 s again, and was stopped 10 s, and the process was repeated, and the number of ablations was calculated. No cracks occurred after the high-entropy alloy block underwent 50 intermittent ablations.

It is apparent that the high-entropy alloy blocks manufactured in Examples 1-4 all exhibit excellent ablation resistance as well as thermal shock resistance, with the high-entropy alloy block manufactured in Example 4 exhibiting the best performance.

Comparative Example 1

A W metal powder, a Mo metal powder, a Ta metal powder and a Nb metal powder were mixed and ball-milled in an equal molar ratio to obtain a mixed powder, wherein a ball-to-powder weight ratio was 5:1, a ball milling speed was 300 r/min, and the ball milling time was 5 h; and the mixed powder was sintered by spark plasma sintering to obtain a high-entropy alloy block, wherein vacuuming was performed to 6 Pa or less before sintering, the temperature was increased from 25° C. to 1500° C. at a heating rate of 50° C./min, heat preservation was performed at 1500° C. for 5 min, the pressure was maintained at 30 MPa during sistering, and after sintering, the temperature was decreased to 500° C. at a cooling rate of 40° C./min, followed by natural cooling to room temperature, the high-entropy alloy block having a melting point of 2161.5° C.

The high-entropy alloy block manufactured in this example was ablated in the same manner as that in Example 1, and FIG. 1 shows a macroscopic optical photograph of the manufactured high-entropy alloy block after ablation. As can be seen from the photograph after ablation, there were obvious ablation pits on the surface, and the ablation resistance was poor.

The present disclosure has been described in detail above with reference to preferred embodiments and illustrative examples. However, it should be noted that these specific embodiments are merely illustrative of the present disclosure and do not limit the scope of protection of the present disclosure in any way. Various improvements, equivalent replacements or modifications can be made to the technical contents of the present disclosure and the embodiments thereof without departing from the spirit and protection scope of the present disclosure, and all fall within the protection scope of the present disclosure. The scope of protection of the present disclosure shall be subject to by the appended claims.

1. A high-entropy alloy for a throat liner, having an expression: WₐMo_{b}Ta_{c}X_{d}, wherein 15%≤a≤50%, and 15%≤b≤50%.

2. The high-entropy alloy for a throat liner according to claim 1, wherein preferably, 15%≤c≤50%.

3. The high-entropy alloy for a throat liner according to claim 1, wherein 0%<d≤50%.

4. The high-entropy alloy for a throat liner according to claim 1, wherein a+b+c+d=100%.

5. The high-entropy alloy for a throat liner according to claim 1, wherein X is any one or more of Nb, Ti, V, Zr, and Hf.

6. The high-entropy alloy for a throat liner according to claim 1, wherein the high-entropy alloy for a throat liner has a density of 10-16 g/cm³ and a densification of 85%-95%.

7. The high-entropy alloy for a throat liner according to claim 1, wherein the high-entropy alloy for a throat liner has a compressive strength of 405-510 MPa at 1600° C.

8. The high-entropy alloy for a throat liner according to claim 1, wherein the high-entropy alloy for a throat liner has an average linear ablation rate of −0.5 μm/s to 5 μm/s after ablated in an oxyacetylene flame with a heat flux density of 4 MW/m² for 240 s.

9. A method for manufacturing the high-entropy alloy for a throat liner according to claim 1, comprising:
Step 1, mixing and ball-milling a W metal, a Mo metal, a Ta metal and an X metal to obtain a mixed powder;
Step 2, sintering the mixed powder to obtain a high-entropy alloy block; and
Step 3, machining the high-entropy alloy block into the high-entropy alloy for a throat liner.

10. A rocket motor, comprising the high-entropy alloy for a throat liner according to claim 1.

11. The rocket motor of claim 10, wherein 15%≤c≤50%.

12. The rocket motor of claim 10, wherein 0%<d≤50%.

13. The rocket motor of claim 10, wherein a+b+c+d=100%.

14. The rocket motor of claim 10, wherein X is any one or more of Nb, Ti, V, Zr, and Hf.

15. The rocket motor of claim 10, wherein the high-entropy alloy for a throat liner has a density of 10-16 g/cm³ and a densification of 85%-95%.

16. The rocket motor of claim 10, wherein the high-entropy alloy for a throat liner has a compressive strength of 405-510 MPa at 1600° C.

17. The rocket motor of claim 10, wherein the high-entropy alloy for a throat liner has an average linear ablation rate of −0.5 μm/s to 5 μm/s after ablated in an oxyacetylene flame with a heat flux density of 4 MW/m² for 240 s.
